(19) United States
(12) Patent Application Publication
(10) Pub. No.: US 2005/0156362 A1
(43) Pub. Date: Jul. 21, 2005

(54) Piezoelectric device and method of manufacturing same

(76) Inventors: Joe Arnold, Palm Beach Gardens, FL (US); Daniel Halpert, Boca Raton, FL (US); Walter Guy Scott, North Palm Beach, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/998,129

(22) Filed: Nov. 29, 2004

Related U.S. Application Data
(60) Provisional application No. 60/525,927, filed on Nov. 29, 2003.
(60) Provisional application No. 60/572,613, filed on May 20, 2004.

(51) Int. Cl. C04B 33/32

(52) U.S. Cl. 264/618; 264/645; 264/642

(57) ABSTRACT

The present invention relates to a device and methods of making the same. The method comprises contacting a ceramic powder with a first polymer and surfactant to form a slip mixture, mixing the slip mixture, injecting the slip mixture into a mold to form a green body, removing the mold from the green body, sintering the green body to form a sintered ceramic body, and embedding the sintered ceramic body in a second polymer to form a composite. An apparatus for forming a net shaped green body includes a mold, supplemental mold and mold assembly.

### CROSS-REFERENCE TO RELATED APPLICATIONS

The present application claims the benefit of U.S. Provisional Patent Application No. 60/525,927, filed Nov. 29, 2003 and U.S. Provisional Patent Application No. 60/572,613, filed May 20, 2004, both of which are incorporated herein by reference in their entirety for all purposes.

### FIELD OF THE INVENTION

The present invention relates to manufacturing and molds.

### RELATED ART

Injection molding has been one technique used to manufacture devices. In injection molding, a material is injected into a mold and hardened or “set” to form a body. Problems can arise that limit the effectiveness of conventional injection molding techniques, especially when devices need to be molded with microsized features. Excessive shrinkage or long set times can occur that limit the effectiveness of conventional injection molding techniques.

What is needed are improved methods of manufacturing and molds suitable therefor.

### SUMMARY OF THE INVENTION

In one embodiment, the present invention relates to a method of manufacturing a device, comprising contacting a ceramic powder with a first polymer and surfactant to form a slip mixture, mixing the slip mixture, injecting the slip mixture into a mold to form a green body, removing the mold from the green body, sintering the green body to form a sintered ceramic body, and embedding the sintered ceramic body in a second polymer to form a composite.

In another embodiment, the present invention relates to an apparatus for forming a net shaped green body in a molding operation, comprising a mold, supplemental mold, and mold assembly.

In another embodiment, the present invention relates to a polymer-ceramic composite comprising a plurality of ceramic elements disposed in a polymer matrix, wherein said elements have dimensions of 150-250 μm in height, 35-60 μm widths and 30-60 μm center-to-center separation between said elements.

These and other embodiments, advantages and features will become readily apparent in view of the following detailed description of the invention.

### BRIEF DESCRIPTION OF THE DRAWINGS/FIGURES

The accompanying drawings, which are included to illustrate exemplary embodiments of the invention and are incorporated in and constitute a part of this specification, illustrate embodiments of the invention and together with the description serve to explain the principles of the invention. In the drawings:

FIG. 1 illustrates a piezoelectric identification device according to an embodiment of the invention.

FIG. 2 illustrates a piezoelectric element according to an embodiment of the invention.

FIG. 3 illustrates a row of piezoelectric elements according to an embodiment of the invention.

FIG. 4 illustrates an array of rectangular piezoelectric elements according to an embodiment of the invention.

FIG. 5 illustrates an array of circular piezoelectric elements according to an embodiment of the invention.

FIG. 6 illustrates a row of rectangular piezoelectric elements having a fill material between elements according to an embodiment of the invention.

FIGS. 7A and 7B illustrate sensor arrays according to embodiments of the invention.

FIG. 8 illustrates a more detailed view of the sensor array of FIG. 7A.

FIG. 9 illustrates how the sensor array of FIG. 8 is connected to an application specific integrated circuit.

FIG. 10 illustrates how to connect a sensory array to multiplexers according to an embodiment of the invention.

FIG. 11 illustrates an identification device according to an embodiment of the invention.

FIG. 12 illustrates circuit components of an identification device according to an embodiment of the invention.

FIG. 13 is a flowchart illustrating the preparation of a slip mixture in accordance with the present invention.

FIGS. 14A-B are flowcharts illustrating methods of manufacturing a sensor device in accordance with embodiments of the present invention.

FIGS. 15A-D illustrate apparatuses for forming a green body in a molding operation according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Reference will now be made in detail to the embodiments of the present invention, examples of which are illustrated in the accompanying drawings.

Table of Contents
I. Overview
II. Example Devices and Systems
   A. Piezo Ceramic Sensors
   B. Piezo Film Sensors
   C. Sensor Array Address Lines
   D. Example Identification Device
III. Methods of Manufacturing
   I. Overview

The present invention relates to methods of preparing a slip mixture, methods of manufacturing a sensor, a piezoelectric identification device, other devices and applications thereof. First, example devices and systems are described. Then methods of manufacturing are described according to embodiments of the present invention.

II. Example Devices and Systems

In an example, a piezoelectric device can be used that obtains biometric data, such as a fingerprint or other biometric data relating to a finger, from a person, and using the obtained information to recognize and/or verify the identify of an individual, see International Appl. No. PCT/US01/09187, which is hereby incorporated by reference herein in its entirety for all purposes. The present invention is not intended to be limited to a capturing biometric data and other types of information, such as medical information, can be captured.

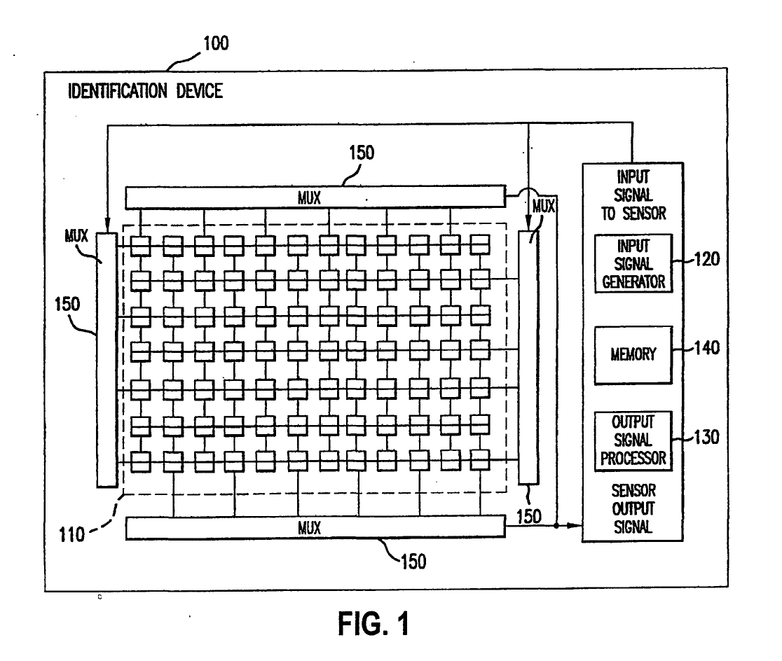

FIG. 1 is a schematic diagram of a piezoelectric identification device 100 according to an embodiment of the invention. Identification device 100 has a piezoelectric sensor 100, a sensor input signal generator 120, a sensor output signal processor 130, and a memory 140. The input signal generated by input signal generator 120 is coupled to sensor 110 by two multiplexers 150. The output signal of sensor 110 is similarly coupled to output signal processor 130 by two multiplexers 150.

A. Piezo Ceramic Sensors

Sensor 110 is preferably an array of piezo ceramic elements. For example, sensor 110 can comprise an array of polycrystalline ceramic elements that are chemically inert and immune to moisture and other atmospheric conditions. Polycrystalline ceramics can be manufactured to have specific desired physical, chemical, and/or piezoelectric characteristics. Sensor 110 is not limited to comprising an array of piezo ceramic elements, however. Sensor 110 can comprise, for example, a piezoelectric film. A polarized fluoropolymer film, such as, polyvinylidene flouride (PVDF) film or its copolymers can be used.

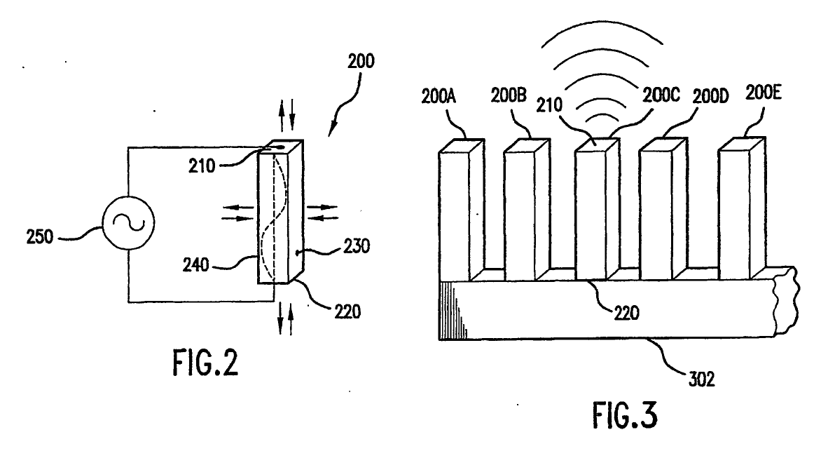

FIG. 2 illustrates the operating characteristics of a signal rectangular piezo ceramic element 200 having surfaces 210, 226, 230, and 240. When force is applied to surfaces 210 and 220, a voltage proportional to the applied force is developed between surfaces 210 and 220. When this occurs, surfaces 230 and 240 move away from one another. When a voltage is applied to surfaces 210 and 220, surfaces 230 and 240 move towards one another, and surfaces 210 and 220 move away from one another. When an alternating voltage is applied to surfaces 210 and 220, piezo ceramic element 200 oscillates in a manner that would be known to a person skilled in the relevant art.

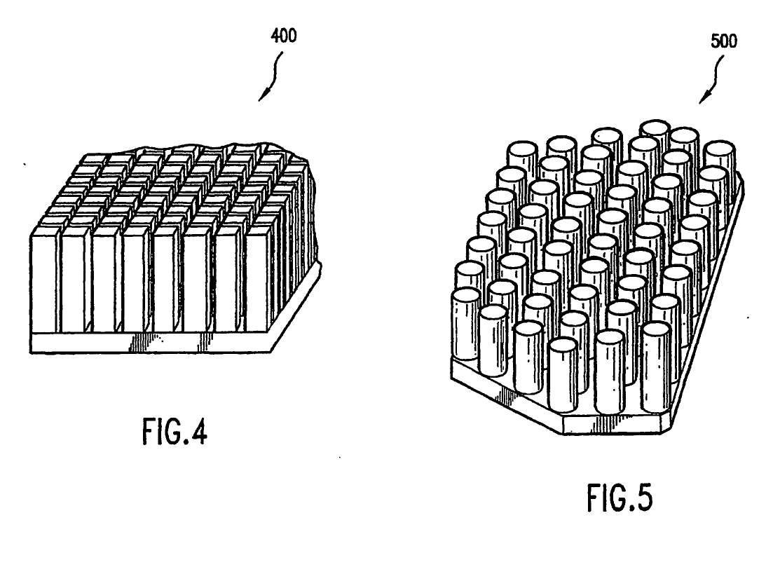

FIG. 3 illustrates a row of five rectangular piezo ceramic elements 200A, 200B, 200C, 200D, and 200E. Each of these rectangular piezo ceramic elements 200 is attached or integral to support 302. Support 302 inhibits the movement of one surface of each rectangular piezo ceramic elements 200. Thus, when an alternating voltage is applied to surfaces 210 and 220 of piezo ceramic element 200C, a sonic wave is generated at surface 210 of piezo ceramic element 200C. The frequency of the generated sonic wave is dependent on the physical characteristics of piezo ceramic element 200C.

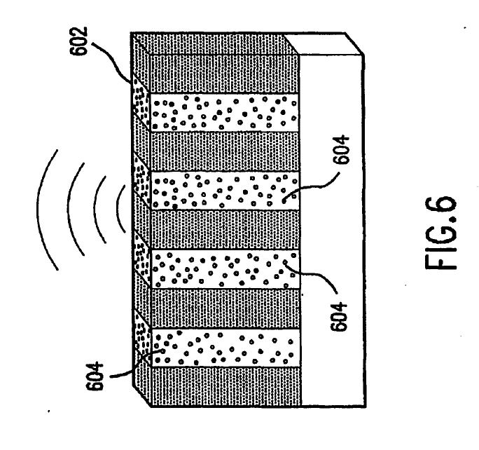

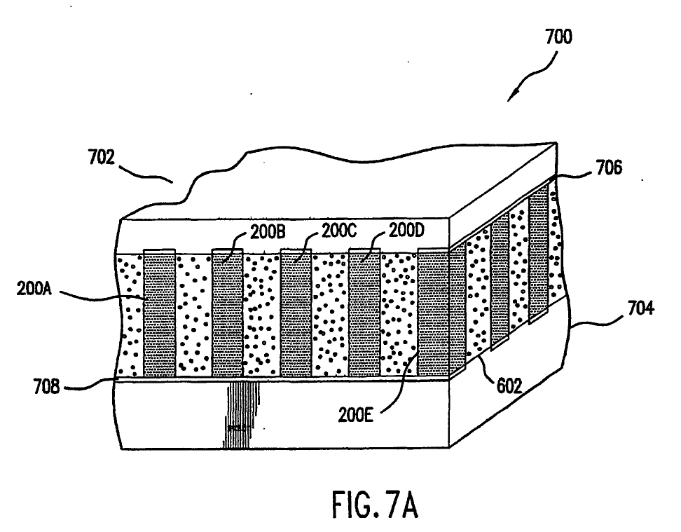

FIG. 4 illustrates a two-dimensional array 400 of rectangular piezo ceramic elements 200. Array 400 can be made from lead zirconate titanate (PZT). PZT is an inexpensive material. In an embodiment, array 400 is similar to a PZT 1-3 composite used in medical applications. The piezo ceramic elements of senor 110 according to the invention can have shapes other than rectangular. As illustrated in FIG. 5, senor 110 can comprise an array 500 of circular piezo ceramic elements.

In a preferred embodiment, array 400 comprises rectangular piezo ceramic elements that are 40 microns square by 100 microns deep, thereby yielding a 20 MHz fundamental frequency sonic wave. A spacing of 10 microns is used between elements in this embodiment in order to provide a 50-micron pitch between elements. A pitch of 50-micron enables an identification device according to the invention to meet the Federal Bureau of Investigation's quality standards for fingerprints. Other embodiments of the invention use geometries different than the preferred embodiment. For example, a pitch of grater than 50 microns can be used. Other embodiments also operate a frequencies of than 20 MHz. For example, embodiments can operate at frequencies of 30 MHz and 40 MHz, in addition to other frequencies.

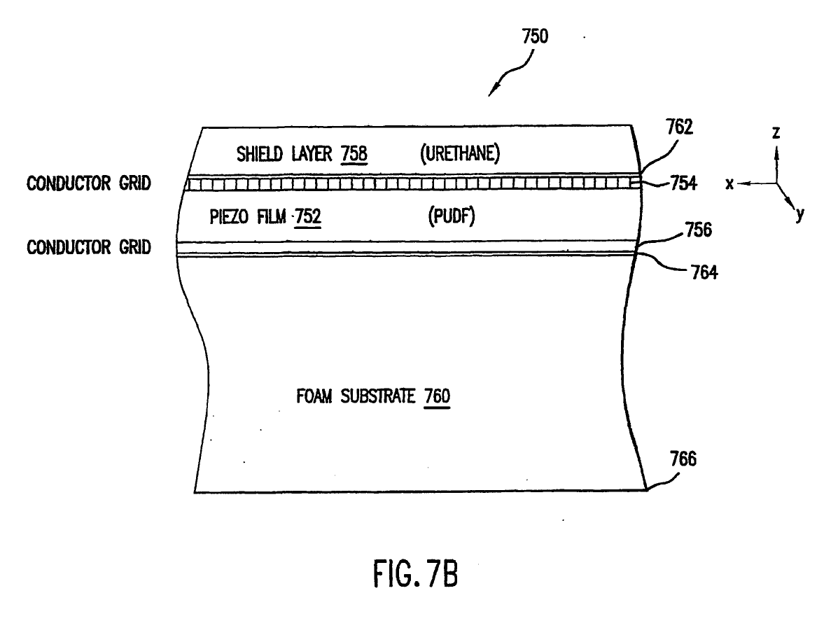

As shown in FIG. 6, the spacing between the elements of a sensor array according to the invention can be filled-in with a flexible type material or filler 602 to suppress any shear waves and give the senor improved mechanical characteristics. Micro-spheres 604 can be add to the filler 602 (e.g., vinyl micro-spheres) to reduce weight and/or increase the suppression of shear waves. In order to optimize the signal-to-noise ratio of an identification device, and the device sensitivity, fillers (e.g., araldite filled with air filled vinyl micro-spheres) that provide high acoustical attenuating and electrical isolation should be used.

At least four fabrication methods exist for producing array 400. These methods include: laser cutting, dicing, molding, and screen-printing. Laser cutting involves using an excimer laser to cut small groves and thereby form the elements of array 400. Dicing involves using high performance dicing equipment to form groves and the elements of array 400. Molding involves using injection molding equipment to form array 400. Screen-printing is a technique similar to that of solder printing in the assembly of printed circuit boards, where highly automated screen printing machines are adapted with laser cut stencils. This method is particularly suited to producing 20 MHz sonic wave elements since the ceramic elements are only 100 microns thick. This method involves producing a ceramic slurry of appropriate consistency, and has the advantage of not requiring surface grinding as may be required with the molding method.

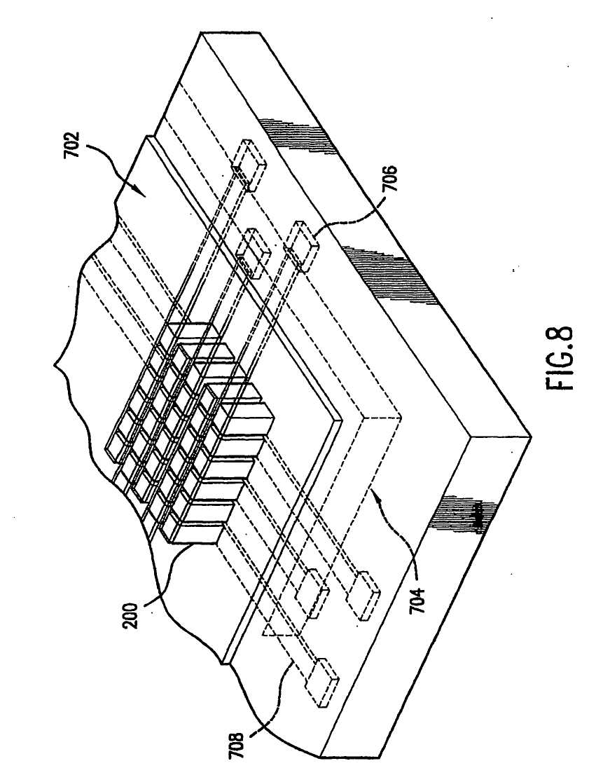

FIG. 7A illustrates a sensor array 700 comprising rectangular piezo ceramic elements according to a preferred embodiment of the invention. Sensor array 700 is a multi-layer structure that includes a two-dimensional array of rectangular piezo ceramic elements 200, similar to array 400. Conductors (such as conductors 706 and 708) are connected to each of the rectangular piezo ceramic elements 200. The conductors connected to one end of each element 200 (e.g., conductor 706) are oriented orthogonal with respect to the conductors connected to another end of each element 200 (e.g., conductor 708). A shield layer 702 can be added to one side to provide a protective coating where a finger can be placed proximate to sensor array 700. A support 704 can be attached to the opposite end of the sensor array. Sensor array 700 is described in more detail below.

B. Piezo Film Sensors

FIG. 7B illustrates a sensor array 750 comprising piezoelectric film (piezo film) according to an embodiment of the invention. FIG. 7B is a cross-sectional view of sensor array 750. Sensor array 750 is a multi-layer structure that includes a piezoelectric layer 752 sandwiched by two conductor grids 754 and 756. Conductor grids 754 and 756 each consist of rows of parallel electrically conductive lines. Preferably, the lines of grid 754 are oriented orthogonal with respect to the lines of grid 756 (that is, in x and y directions, respectively). This orientation creates a plurality of individually addressable regions or elements in the piezo film. As used herein, the term element refers to any region of a senor array that can be addressed, either individually or as part of a larger region, using the rows of parallel electrically conductive lines (conductors). Piezoelectric polymer film sensors are further described in Piezo Film Sensors: Technical Manual, available from Measurement Specialities, Inc. Norristown, Pa., Apr. 2, 1999 REVB (incorporated by reference herein in its entirety).

Shield layer 758 can be added to one side where a finger is placed to provide a protective coating. Foam substrate 760 can be used as a support. As shown in FIG. 7B, the multiple layers of sensor array 750 are stacked along one direction (e.g., a z-direction).

In an embodiment, piezo layer 752 is a polarized fluoropolymer film, such as, polyvinylidene flouride (PVDF) film or its copolymers. Conductor grids 754 and 756 are silver ink electrodes printed on opposite sides of the PVDF film 752. Shield layer 758 is made of urethane or other plastic. Foam substrate 760 is made of TEFLON. An adhesive 762, 764 holds shield layer 758 and foam substrate 760 on opposite sides of the printed PVDF film 752 as shown in FIG. 7B.

In an embodiment, the PVDF film, including the printed electrodes, can be peeled off like a label for easy replacement. As shown in FIG. 7B, sensor array 750 can be mounted by adhesive 766 onto wax paper or other material (not shown) for easy peel off. This allows the piezo sensor to be installed and/or replaced simply and easily at minimum cost. Compared to optical and silicon technologies, maintenance of the piezo sensor array 750 is trivial.

C. Sensor Array Address Lines

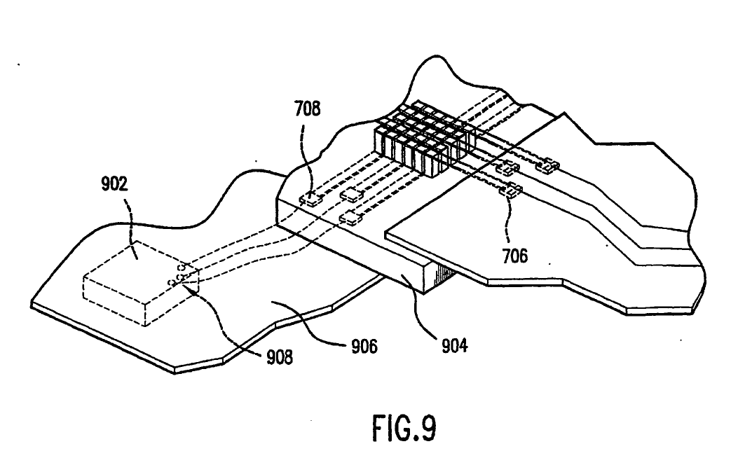

FIG. 8 illustrates a more detailed view of sensor array 700. As described above, sensor array 700 comprises piezo ceramic elements having an filler 602. Filler 602 preferably contains micro-spheres 604. This structure is then sandwiched between several layers. This central composite layer is an active structure that can be used, for example, to map fingerprint mechanical impedances into a matrix of electrical impedance values.

Each rectangular piezo ceramic element 200 of sensor array 700 is connected to two electrode lines (e.g., conductors 706 and 708). The electrode lines on one end of sensor array 700 run perpendicular to the electrode lines on opposite end of sensor array 700. Thus, any single element 200 of the array can be addressed by selecting the two electrode lines connected to it. The electrode lines are preferably created by vacuum despoliation and lithography, and they are connected to the switching electronics via an interconnect technique described below.

On top of the one set of electrode lines is a protection layer 702. Protective layer 702 is preferably made of urethane. This protecting layer is intended to be in contact with a finger during operation of the sensor.

A support 704 or backing layer serves as a rear acoustical impedance for each of the rectangular piezo ceramic elements 200. In a preferred embodiment, support 704 is made of TEFLON foam. In order to provide a large variation of the electrical impedance of an element when loaded and unloaded, the acoustical impedance support 704 should be acoustically mismatched to the sensor element material. Either a very low or a very high acoustic impedance material can be used. For embodiments using piezo ceramic materials, the preferred impedance mismatch can be obtained by an air backing rather than by a hard backing. This is because the sensor has a high acoustic impedance.

The materials described herein for constructing sensor array 700 are illustrative and not intended to limit the present invention. Other materials can, as would be know to a person skilled in the relevant art, be used.

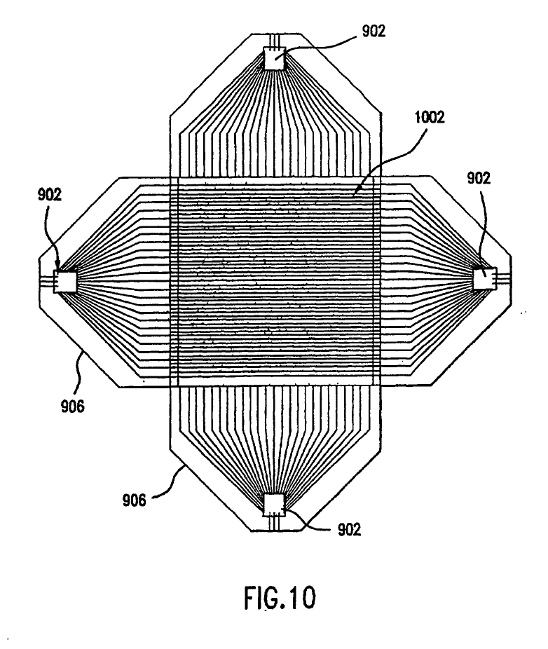

FIG. 9 illustrates how sensor array 700 can be connected to an application specific integrated circuit. As described herein, an individual piezo ceramic element (m, n) of sensor array 700 can be addressed by selecting (addressing) conductor m on the top of sensor array 700 and conductor n on the bottom of sensor array 700. Other conductors can be either grounded or open (high impedance state), particularly those conductors used to address elements in the neighborhood of the element being selected, in order to reduce cross-talk. Parasitic currents in the neighborhood of the selected element are minimized mechanically by the interstitial filler 602, described above with regard to FIGS. 6 and 7A. Since in the preferred embodiment, the spacing between elements (pitch) is about 50 microns and standard bonding technologies require a pitch of about 100 microns, alternate rows on an “East” and “West” and alternate columns on a “North” and “South” sides of sensor array 700, as shown in FIG. 9, connect the sensor to the “outside world”. As shown in FIG. 9, These conductors can be terminate in a “Bump” technology around three edges 908 of an ASIC multiplexer 902. In an embodiment, side 908 of ASIC multiplexer 902 is about 3 mm.

In an embodiment, ASIC multiplexer 902 is connected to a high density flex 906. High density flex 906 is connected to an epoxy substrate 904. Conductors can be formed or attached to the high flex to couple the conductors of the array to ASIC multiplexer 902. For example, a conductor on high density flex 906 is shown in FIG. 9 coupling conductor 708 to ASIC multiplexer 902. Conductor is coupled to ASIC multiplexer 902 by bump soldering. Anisotropic glue can be used to couple the conductor on high density flex 906 to conductor 708 of the sensor array. Other means for connecting and electrically coupling ASIC multiplexer 902 to sensor array 700 are known to persons skilled in the relevant art, and these means also can be used in accordance with the invention.

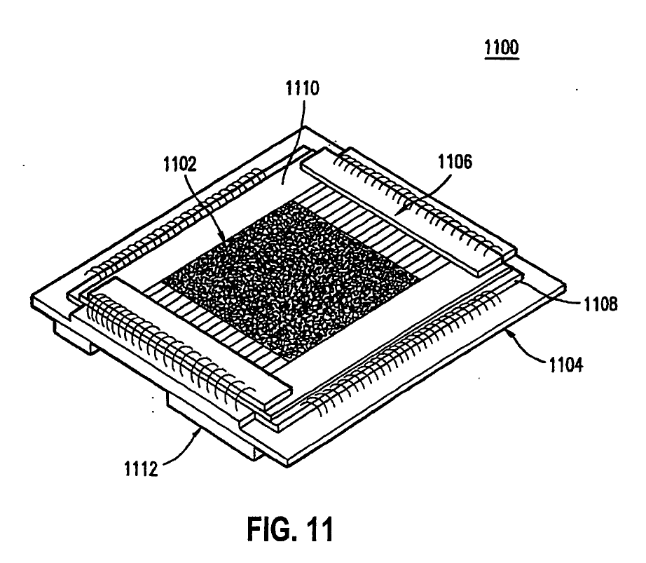

FIG. 10 illustrates how to connect a sensory array 1002 to four ASIC multiplexers 902 according to an embodiment of the invention. As described herein, electrode lines or conductors can be vapor deposited on both sides of the substrate 902 (not shown in FIG. 10) and then etched into the desired pattern. Before the line and row pattern is etched, substrate 902 should be polarized in a manner similar to that of medical transducers.

A polarized substrate is connected to a socket or multi chip module case that is compatible with available printed circuit board technologies. The piezo ceramic matrix or sensor array 1002 can be backed by an air equivalent foam or aluminum oxide. Either backing is designed to miss-match the composite piezo material at 8 Mrayls to cause any energy coupling to occur only at the front face of sensor array 1002, where for example a fingerprint can be scanned. It should be noted in FIG. 10 that the conductors on both the top and bottom of sensor array 1002 are interleaved in the manners described above to facilitate bonding technologies requiring a pitch of about 100 microns.

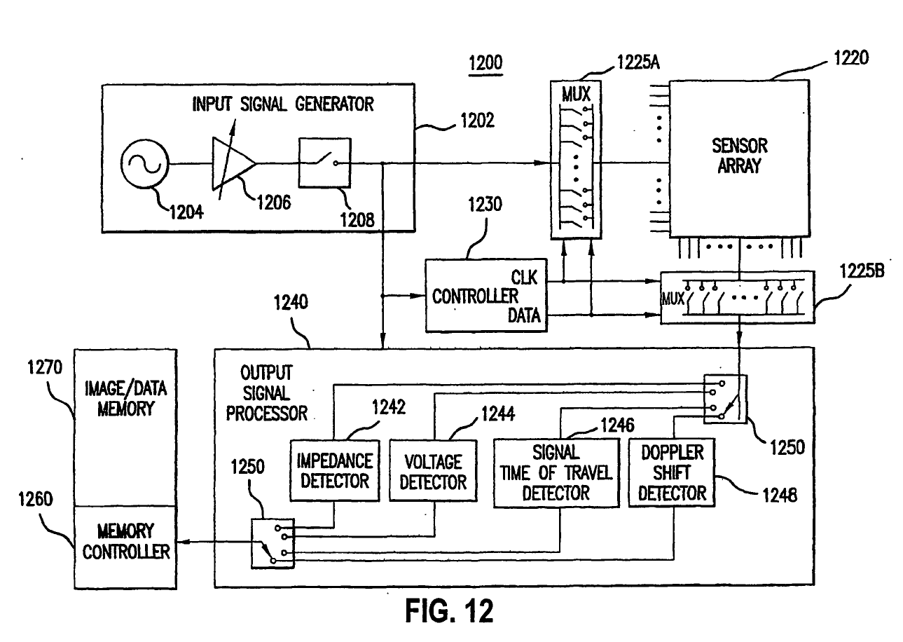

FIG. 11 illustrates an identification device 1100 according to an embodiment of the invention. In a preferred embodiment, device 1100 has a piezo ceramic sensor array 1102 that is physically lager enough to capture any fingerprint placed without accuracy on sensor array 1102 (e.g., about 25 mm square). Sensor array 1102 is preferably compliant with CJIS ANSII NIST standards in resolution (500 points per 25.4 mm), and it has a pixel dynamic range sufficient to provide 256 distinct shades of gray.

As show in FIG. 11, in an embodiment, substrate 1110 is attached to a printed circuit board 1104. The conductors of sensor array 1102 are coupled to two integrated circuits 1106 and two integrated circuits 1108, which couple sensor array 1102 to other circuits, which are described elsewhere herein. Integrated circuit 1112 is a wireless transceiver that enables embodiments of the invention to communicate with other devices as part of a personal area network. This connectivity permits embodiments of the invention to supply, for example, a standard secure identification and/or authorization token to any process or transactions that need or require it. The connection scheme shown is FIG. 11 is an alternative connection scheme that can be used to implement embodiments of the invention.

The above sensor array descriptions are illustrative and not intended to limit the present invention. For example, piezo layer 752 can be any material exhibiting a piezoelectric effect including, but not limited to, piezoelectric polymers. Conductor grids 706, 708, 754 and 756 can be any electrically conductive material including, but not limited to, metals. Likewise, other types of protective material can be used for shield layers 702 and 758 as would be apparent to a person skilled in the art given this description. Other types of supportive material can be used in place of support 704 or foam substrate 760.

D. Example Identification Device

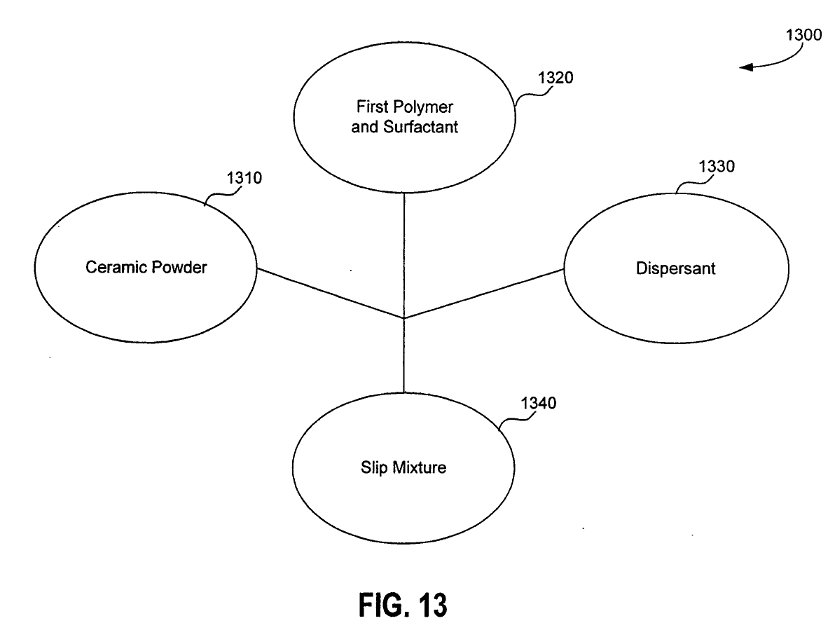

FIG. 12 illustrates an identification device 1200 according to an embodiment of the invention. Device 1200 comprises an input signal generator 1202, a sensory array 1220, an output signal processor 1240, a memory controller 1260, and a memory 1270. Sensor array 1220 is coupled to input signal generator 1202 and output signal processor 1240 by multiplexers 1225A and 1225B, respectively. A controller 1230 controls the operation of multiplexers 1225A and 1225 B. The operation of identification device 1200 is further described below.

In an embodiment, input signal generator 1202 comprises an input signal generator or oscillator 1204, an variable amplifier 1206, and a switch 1208. In a preferred embodiment, oscillator 1204 produces a 20 MHz signal, which is amplified to either a low or a high voltage (e.g., about 4 volts or 8 volts) by variable amplifier 1206, depending on the mode in which device 1200 is operating. Switch 1208 is used to provide either no input signal, a pulsed input signal, or a continuous wave input signal. Switch 1208 is controlled to produce the various types of input signals described herein in a manner that would be known to a person skilled in the relevant art. As shown in FIG. 12, the input signal generated by input signal generator 1202 is provided to sensor array 1220, through multiplexer 1225A, and to controller 1230 and output signal processor 1240.

The structure and details of sensor array 1220 are explained above. In a preferred embodiment, sensor array 1220 is a piezo ceramic composite of rectangular elements designed to operate with a 20 MHz input signal.

III. Methods of Manufacturing Device

In another embodiment, the present invention relates to a method of manufacturing a device, comprising contacting a ceramic powder with a first polymer and surfactant to form a slip mixture, mixing said slip mixture, injecting said slip mixture into one or more molds to form a net-shaped green body, removing said mold(s) from said green body, sintering said green body to form a sintered ceramic body, and embedding said sintered ceramic body in a second polymer to form a composite.

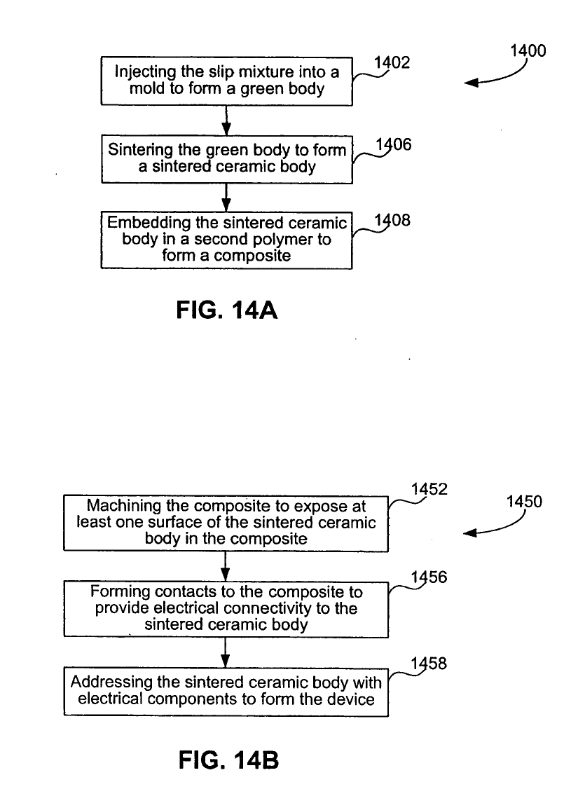

For example, FIG. 13 shows flow chart 1300, showing example steps for producing a slip mixture. A ceramic powder, 1310, is contacted with a polymer and surfactant, 1320, and, optionally, a dispersant, 1330, to form a slip mixture, 1340. The ceramic powder for use in the present invention can be any piezoelectric ceramic powder material. Such materials are well known in the art. Specific examples include but are not limited to barium titanate, lead titanate, lead zirconate, lead zirconate titanate (PZT), lead niobium titanate (PNT), lead scandium niobium titanate (PSNT), and other compounds having the structures (Ba,Sr)TiO₃, (Pb,Sr)(Zr,Ti)O₃, Pb(Fe,Ta)O₃, (KBi)TiO₃. A preferred material for use in the present invention is Pb(Zr, Ti)O₃ (lead zirconate titanate, PZT). The commercially available powder can be further processed to a desired form, such as that form having a defined particle size distribution. The powder can be ground or sheared into its desired form neat, or alternatively, as a mixture comprising the powder and other materials.

The ceramic powder is contacted with a polymer and surfactant to form a slip mixture. Polymer slip mixtures of the present invention comprise low wt. % of polymer. For example, the polymer slip can comprise 1-5 wt. % polymer. Polymers for use in the present invention include any polymers that bind the ceramic powders, are moldable as part of the slip mixture and form slip mixtures having viscosities low enough to be flowable, pourable or injectible. The term “polymer” includes polymer precursors, pre-polymers, and uncrosslinked polymers mixed with cross-linking agents. In one example, the polymer is a thermosetting polymer. Particular examples of polymers include, but are not limited to, polyesters, polyurethanes, silicone rubbers and epoxy polymers. A preferred polymer is low viscosity epoxy polymer.

The phrase “epoxy polymer” is used herein to refer to uncured epoxy precursors, mixed epoxy precursors and the finished, cured or cross-linked epoxy polymer. Epoxy polymers for use in the present invention include, but are not limited to, two-part epoxy precursors, three-part epoxy precursors, or epoxy precursors having more than three parts. One example of a two part epoxy precursor includes, but is not limited to, a precursor having two or more amine functional groups and another part having two or more epoxide functional groups. Epoxy resins are well known to one of ordinary skill in the art. Specific examples of epoxy polymers include D.E.R. 300 and 600 series epoxy resins (available from Dow Chemicals, Inc.) and the polymer that results from a first part RBC-3200 A epoxy resin and a second hardener part RBC-3200 B120 (available from RBC Industries, Inc.).

Preferably, the cure or set time for a thermosetting polymer used, for example, an epoxy polymer, is long enough to allow mixing of the polymer slip mixture and injection into the mold before the thermosetting polymer hardens. For example, the set time is about 10 minutes to about 48 hours, preferably about 30 minutes to about 3 hours.

The use of surfactants and dispersants in ceramics manufacturing is well known to one of ordinary skill in the art. Dispersants and surfactants, and optionally other additives, are used to control the stability, wettability, flowability, viscosity and other properties of the polymer slip mixture. Any surfactant that is compatible with organic polymers can be used. Preferably, the surfactant lowers the surface tension of the polymer and is capable of stabilizing the slip mixture and/or facilitating the formation and molding of the slip mixture. Specific examples of surfactants for use in the present invention include, but are not limited to, Dow Corning 57 surfactant, Fluorad™ FC-4430 surfactant, Fluorad™ FC-4432 surfactant, Surfonic PE-1198 surfactant and KEN-REACT® KR-55 surfactant.

The pre-mixture optionally further comprises dispersant. Dispersants for use in the invention are those that facilitate the mixing of the ceramic powder with the pre-mixture. An example of a suitable dispersant is Disperbyk 110. The pre-mixture also optionally comprises a surfactant. Any surfactant that improves the mixing and/or wetability of the pre-mixture can be used. One example of a suitable surfactant is Ken React® KR 55 (available from Kenrich Petrochemicals, Inc. Bayonne, N.J.).

Any dispersant capable of facilitating the dispersion of the ceramic powder into the slip mixture and/or facilitating the formation and molding of the slip mixture can be used in the present invention. Specific examples of dispersants for use in the present invention include, but are not limited to, DYSPERBYK® 110 dispersant and Dequest 2010 dispersant.

In one embodiment, therefore, polymer, a dispersant and a surfactant are mixed to form a pre-mixture. The pre-mixture is mixed with the ceramic powder, at least about 60% volume fraction of 1.9 m²/gm ceramic powder powder, e.g. PZT powder, to form the slip mixture.

See also, the polymer slips and methods for manufacturing ceramic green bodies described in a co-pending, commonly-owned patent application entitled “Polymer Slip and Method of Manufacturing Ceramic Green Bodies Therefrom,” by J. Arnold et al., Appl. No. (to be assigned), filed herewith (Atty. Docket No. 1823.1220000), incorporated in its entirety herein by reference.

The slip mixture is mixed in small volumes of ˜4-12 ml in a kinetic mixer in a shear mixing chamber, under active vacuum in a short enough period of time before curing of the slip mixture, e.g. about 15 minutes. Another embodiment of the present invention, therefore, relates to a kinetic shear vacuum mixer for producing slip mixtures.

The shaker type mixer mills commercially available such as the SPEX CertiPrep 8000M mix materials by rapidly moving a small container in a reversing arc. The material consequently goes back and forth along the top of the container. Balls may be added to assist with the mixing, but there is no provision for vacuum to remove gases. Without the removal of gases, the slip structure that forms is inferior and upon fabrication of a sensor array and device, the device fails to operate within specification. Because of these limitations, a kinetic mixture solving the problems described above was developed.

Fine powder, being mixed with a small amount of liquid has air attached to its large surface area that must be replaced by a liquid. The dislodged air must be removed to avoid air bubbles in the mixture. A vacuum source at the horizontal center line is out of the path of the items being mixed, and can remove dislodged air.

In this device, cylindrical protrusions from the upper wall interrupt the path of the mixture, causing shear, turbulence, air dislodgment, and good mixing. Specific kinetic shear mixers for use in the present invention include those described in a co-pending, commonly-owned U.S. Patent Application, entitled “Kinetic Shear Mixer and Method”, by J. Arnold, Appl. No. to be assigned, filed herewith (Atty. Docket No. 1823.1250000), which is incorporated herein by reference in its entirety for all purposes.

Another embodiment of the present invention, therefore, relates to a method of producing a slip for forming a ceramic, comprising contacting a ceramic powder with a pre-mixture comprising dispersant, polymer and surfactant to form a crude slip mixture; and mixing the crude slip mixture in a kinetic vacuum and shear mixer to produce a mixed slip mixture. The method also relates to the mixing of large quantities of slip mixture that allow for the production of mixed slip mixtures.

The method of the present invention further comprises optional further processing steps. For example, after mixing, the slip is transferred to a syringe. The slip is vacuum deaired in the syringe to remove any air entrained in transferring. In an example, slip is mixed in a kinetic shear mixer with retractable elements and a piston for ejecting the slip from the mixer directly into a mold as described for example in co-pending, commonly-owned U.S. Patent Application, entitled “Kinetic Shear Mixer and Method”, by J. Arnold, Appl. No. to be assigned, filed herewith (Atty. Docket No. 1823.1250000), which is incorporated herein by reference in its entirety for all purposes. The slip is then ready for mold casting.

Because slip mixtures of the present invention have little shrinkage, precision molding of net-shaped green bodies having microsized elements and/or features is possible. “Net-shaped” is used herein to mean that green bodies of the present invention have high-quality, microsized elements or features upon molding, and generally no additional machining or processing to achieve high quality, microsized features or elements is required. Slip mixtures of the present invention have substantially no distortion upon setting. The phrase “substantially no distortion” is used herein to mean flat surfaces of the molded slip mixture remain flat upon setting, hardening and/or curing the molded slip mixture to form the green body, and the surfaces of the green body are smooth and essentially free of defects larger than about the grain size of the ceramic powder. Defects include, but are not limited to, holes, bubbles, cracks and the like. The slip mixtures, therefore, can be molded to net-shaped green bodies, have high quality microsized structural elements, and the green bodies can have overall large dimensions.

The combination of microsized elements and large green bodies greatly expands the applicability of the molded articles. For example, slip mixtures of the present invention can be used to form ceramic bodies for use as piezoelectric sensors for a wide range of applications, including, but not limited to, biometric data collection devices, sound dampening devices, or other passive or active piezoelectric devices. Biometric data collection devices can include, but are not limited to, piezoelectric identification devices that capture images of fingerprints as described, for example, in International Patent Appl. No. PCT/US01/09187, incorporated herein by reference in its entirety for all purposes.

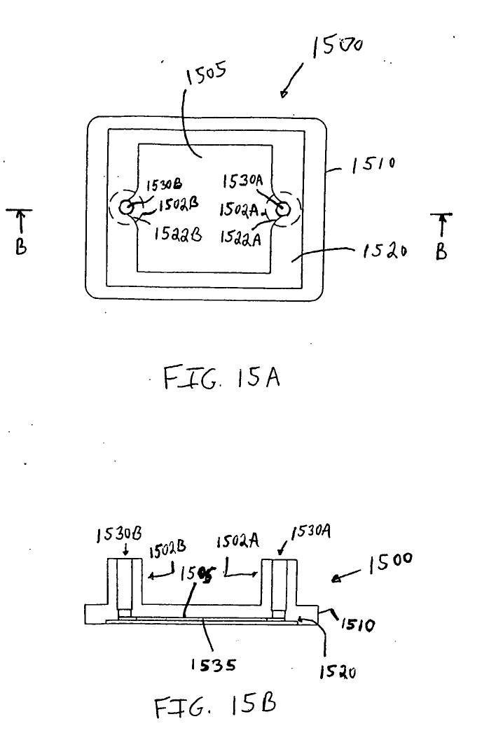

FIG. 14A shows flowchart 1400, showing example steps for manufacturing the device. For example in step 1402, the slip mixture is injected into a mold to form a green body or molded structure. The mold can be but is not limited to a closed mold as described further below. In step 1406, the green body is sintered to form a sintered ceramic body. Step 1406 follows, in which the sintered ceramic body is embedded in a second polymer to form a composite.

FIG. 14B shows flowchart 1450, showing further steps in manufacturing the device, in accordance with an embodiment of the present invention. Flowchart 1452 begins with step 1452. The composite is machined to expose at least one surface of the sintered ceramic body in the composite (for instance, two opposing surfaces on opposite sides of the sintered ceramic body are exposed). Step 1456 follows, in which contacts are formed to the composite to provide electrical connectivity to the sintered ceramic body. In step, 1458, the sintered ceramic body is addressed with electrical components to form the device.

In step 1402, the slip mixture is injected into one or more molds. Any method known to one of ordinary skill in the relevant art can be used to inject or transfer the slip mixture into the mold. For example, the mold is first evacuated under reduced pressure by applying a vacuum to the mold. Second, the slip mixture is injected into the mold using pressure. Pressures for use in step 1402 include any pressure capable of injecting the mixture into the mold. In one example, a pressure of about 5-100 p.s.i. at a temperature of about 20-40° C. is used. In another example, the mixture can be injected directly from a kinetic shear mixer to one or more molds using pressure.

The molds used for molding the slip mixture and forming the green body can be any mold capable of forming and releasing microsized structural elements in the green body. The slip mixture can be molded in a closed mold. Therefore, the molds used for molding the slip mixture can be open or closed molds. The phrase “closed mold” is used herein to refer to a sealable mold, which has little or no ventilation, or allows essentially no evaporation of solvents, liquids, gases, vapors or the like from the slip mixture during the time it takes to mold and set the slip mixture. The closed molds of the present invention optionally allow for the absorption of solvents, liquids, gases, vapors or the like into the mold body. Preferably, there is no absorption into the body of the closed mold. The phrase “open mold” is used herein to refer to an unsealed mold, which has ventilation, or allows for evaporation of solvents, liquids, gases, vapors or the like from the slip mixture. The open molds of the present invention optionally allow for the absorption of solvents, liquids, gases, vapors or the like into the mold body. Preferably, the slips of the present invention do not require or utilize surface evaporation or mold absorption.

Molds of the present invention (such as mold 1500 and supplemental mold 1550 described below) can be made of any material capable of forming microsized structural elements in the slip mixture and green body, and releasing the molded microsized elements without damage. Examples of materials for use as molds include, but are not limited to, plastics and rubbers. Specific examples of materials include, but are not limited to, low durometer (hardness of less than about 40 A) thermoset polyurethanes and silicones. The mold used to form the molded slip structure or green body, in one example, is fabricated from silicone. A very soft, tough silicone (Dow Corning Silastic V) is used for top and bottom components that completely surround the resulting molded slip structure.

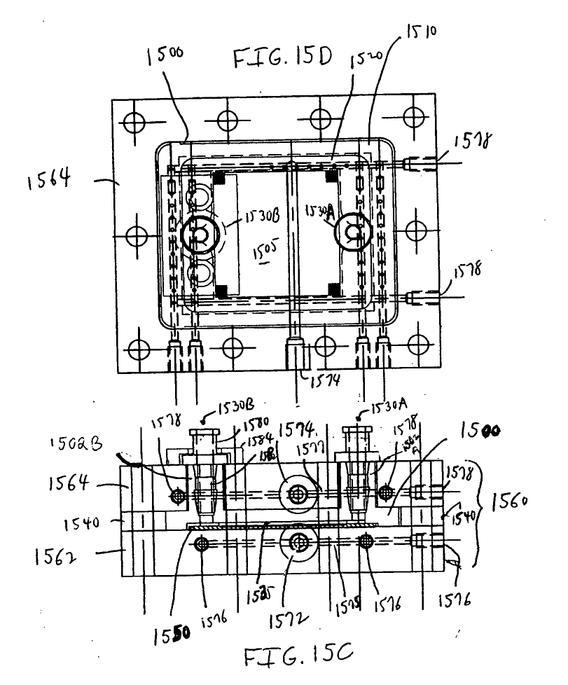

In another embodiment, the present invention relates to an apparatus for forming a net shaped green body in a molding operation, comprising a mold, and a mold area within the mold, said mold area having a reverse shape of the net shape green body being formed. An example apparatus is described below with reference to FIGS. 15A-D. In one example, the reverse shape comprises a plurality of microsized wells having depth of about 300-400 μm, widths of about 30-50 μm and center-to-center spacing between said wells of about 20-60 μm.

FIGS. 15A-15D are diagrams illustrating a mold, spacer, and vacuum/injector mold assembly according to further embodiments of the present invention. FIG. 15A shows a top view of a mold 1500 bounding a mold surface area 1505. Mold 1500 includes an outer mold section 1510 and inner mold section 1520. Outer mold section 1510 includes two columns 1502A, 1502B for receiving respective vacuum/injector ports 1530A, 1530B. Inner mold section 1520 can further include bow regions 1522A, 1522B which are located on opposite sides of mold surface area 1505 and shaped in an arcuate or bow shape to accommodate respective injector ports 1530A, 1530B and not block a vacuum or material being injected therethrough.

FIG. 15B shows a cross-sectional side view taken along line BB of mold 1500. Outer mold section 1510 acts as a base with columns 1502A, 1502B extending upward from the base. Inner mold section 1520 and mold surface area 1505 are recessed within an underside surface of outer mold section 1510 as shown in FIG. 15B. Mold surface area 1505 is further recessed from inner mold section 1520 such that a mold space 1535 may be formed. Columns 1502A, 1502B can accommodate and support vacuum/injection ports 1530A,B. In an embodiment, material can be injected through one of ports 1530A or 1530B to enter mold space 1535 while a vacuum pressure is applied to the other of ports 1530 A or 1530B.

In an example, mold 1500 (including outer and inner molds sections 1510 and 1520) is made of silicone rubber and has an approximately rectangular or square shape and surrounds an approximately rectangular or square shape mold surface area 1505. Mold area 1505 has a shape that is the reverse of a net shape green body being molded. For instance, it can be a flat surface corresponding to a backside of a green body. These shapes are illustrative and not intended to limit the present invention. Other shapes can be used depending upon a desired net shape green body being molded in mold area 1505. Mold 1500 is not limited to two mold sections and can be a single integral piece or can have more than two sections.

FIG. 15C shows a cross-sectional side view of mold 1500, supplemental mold 1550 and vacuum/injector mold assembly 1560 according to an embodiment of the present invention. Supplemental mold 1550 is a separate mold used to further shape a green body within mold space 1535. For instance, supplemental mold 1550 can be placed within inner mold section 1520 opposite mold surface area 1505 as shown. Both mold 1500 and supplemental mold 1550 can be positioned within vacuum/injector mold assembly 1560 during a molding operation.

Vacuum/injector mold assembly 1560 includes a bottom mold vacuum chuck 1562 and a top mold vacuum chuck 1564 separated by spacer 1540. Bottom mold vacuum chuck 1562 has an inner flat surface to support spacer 1540, mold 1500, and supplemental mold 1550. Top mold vacuum chuck 1564 includes holes for receiving columns 1502A,B of mold 1500.

Bottom mold vacuum chuck 1562 includes a bottom vacuum port 1572 on a front side as shown in FIG. 15C. Bottom vacuum port 1572 can be coupled to conduits 1575 which have openings out to the inner flat surface that holds master mold 1550 and other openings sealed by sealing plugs 1576. Similarly, top mold vacuum chuck 1564 includes a top vacuum port 1574 on a front side as shown in FIG. 15C. Top vacuum port 1574 can be coupled to conduits 1577 which have openings out to an inner flat surface that holds mold 1500 and other openings sealed by sealing plugs 1578.

During a molding operation, a vacuum can be applied to each vacuum port 1572, 1574. This vacuum which can be a low pressure less than ambient pressure. In an example, a low pressure of about 0.5 or less is applied to ports 1572, 1574. This vacuum helps hold mold 1500 in place within mold assembly 1560 relative to top vacuum chuck 1564. This vacuum also helps hold mold 1500 and master mold 1550 in place against bottom vacuum chuck 1562.

During a molding operation, material is injected through one of ports 1530A or 1530 B while a second vacuum pressure is applied to the other of port. In an example, a second vacuum pressure of about 2 p.s.i. is applied to a port (i.e. port 1530B), while a material such as a polymer ceramic slip described above is injected into port 1530A. This second pressure is slightly higher than the first vacuum pressure so that master mold 1550 and mold 1500 remain in place during the molding operation. The applied first and second vacuum pressures also means that the pressure within mold space 1535 will be lower than the pressure outside mold assembly 1560 which facilitates fast injection of material through injectors ports 1530A,B without introducing undesirable gas or contaminants into an injection molding operation, or trapping resident gas within mold features.

In one example not intended to limit the present invention, injector ports 1530A, 1530B can also each include a head member 1580, neck member 1582, and holding member 1584. For clarity of illustration, FIG. 15C only shows head member 1580, neck member 1582, and holding member 1584 with respect to injector port 1530B. Head member 1580 extends outside of top mold vacuum chuck 1564 to allow a hose or other fitting to be attached so that material can be injected into port 1530B. Neck member 1582 extends through a respective column 1546 of spacer 1540. Holding member 1584 holds neck member 1582 in place with respect to top mold vacuum chuck 1564.

FIG. 15D further shows a cross-sectional view of a vacuum/injector mold assembly 1560 taken along a direction from a top view down through top mold vacuum chuck 1564 according to an embodiment of the present invention. Vacuum/injector mold assembly 1560 is not limited to top and bottom mold vacuum chucks 1562, 1564. A single support chuck member that can open to receive mold 1500 and supplemental mold 1550, or other type of mold support members may be used.

Molds 1500 and 1550 are formed in specially designed master molds that provide precise internal features, flat external surfaces, and slip injection and vent ports. In one example, master molds used to fabricate silicone molds (i.e., molds 1500, 1550) are preferably a polymeric mold, e.g. polyurethane. One side replicates a master of the pillar configuration and becomes the mold for the piezoelectric ceramic pillars or elements (i.e. supplemental mold 1550) The other side forms a precise, flat backside of the pillar body (i.e. surface 1505 of mold 1500).

In an example, molds 1500, 1550 are silicone molds and are positioned correctly in relation to each other with each back surface on a vacuum chuck in backing walls. The backing walls are positioned by spacers and screws so there is adequate contact to effect a seal but to provide a controlled and limited compression in the silicone. The vacuum chucks (such as, chucks 1562, 1564) are activated with a full vacuum applied to both vacuum chucks to assure that the silicon mold back surfaces are in full contact with the backing walls. This vacuum is maintained throughout the forming process until the epoxy binder is dimensionally cured.

In one example, an assembled silicone mold is placed in a chamber that can be evacuated to near full vacuum. An injector or syringe is connected to a valve and tube that is injected through a rubber port in the chamber and into a mold port inlet.

After an adequate period of evacuation at full vacuum, the pressure is increased to about 25 in. Hg. The valve is opened and slip is injected into the mold and into an exit stand pipe. When this is complete the valve is closed. The chamber pressure is then brought to one atmosphere. The molded slip structure encased in the silicone mold is removed. The slip structure is cured at ambient temperature until it is firmly set. The silicone mold components containing the set slip is removed and further curing is accompanied at 65° C. for about 2 hours. When cooled, the silicone mold parts are peeled off the molded slip structure.

The molded green body or slip structure can be sintered by any process known to one of ordinary skill in the art. Preferably, the slip structure is sintered thermally by heating the slip structure to a temperature sufficient to cause sintering of the slip structure, form a ceramic body and incinerate the polymer binder. In one example, the green body is heated at a temperature of about 500-1500° C. In another example, the slip structure is placed on a flat ground magnesia surface in an alumina crucible also containing PZT powder, and placed in a furnace. Over a period of about 2 days the temperature is raised to about 650° C. and returned to about 25° C. to remove the epoxy binder without distorting the PZT ceramic. An alumina cover is then placed on the crucible, in the furnace. The temperature is slowly raised to the sintering temperature of the PZT powder, held for an appropriate time, and cooled to about ambient temperature.

The resulting sintered ceramic body can be further processed in a number of optional steps. For example, the resulting body is placed pillars down on a silicone mold with locating features to elevate the pillars above the bottom surface and to accurately centrally locate it. It is placed in a vacuum chamber and the body is encased in a second polymer to form a composite. Any polymer can be used for the encasing, preferably, a clear epoxy (e.g. Epotek 301-2) is used. In such an example, the epoxy is injected thru the wall via a syringe into the mold cavity. After the epoxy has covered the mold bottom and has fully encircled the body, the chamber is repressurized, fully infiltrating the pillars. The filled infiltrated mold is cured at ambient temperature. It is then removed from the mold.

The epoxy sheet with the embedded body structure is placed on a vacuum chuck with the mold side down. The composite can be further processed in a number of optional steps. For example, the composite is machined to a desired shape, exposing at least one surface of the sintered ceramic body. Two surfaces on opposite sides of the body may be exposed in the case of a manufacture of a piezoelectric sensor or transducer. In this example, the exposed side of the composite is ground with a diamond grinding wheel until the backing plate is removed, the plate ends of the pillars are exposed, and a plane is established through the sheet that is parallel to the other face. The part is then turned over on the vacuum chuck and ground until the excess epoxy is removed, the pillar ends are exposed in a plane through the sheet parallel to the other face, and the desired thickness is reached.

In the example, the ground epoxy sheet now contains an array of PZT rods, located in the central area of the sheet that are properly positioned and aligned with the edges. The pillars can then be metallized and addressed to form a device. In one example, metallic electrodes are applied to the pin ends by applying wet or dry film negative photo resist to one entire surface, exposing the photo resist from the other side using the PZT rods as their own mask. When developed, the rod ends are bare leaving photo resist on the epoxy. The back side is then masked with photo resist.

Any method of electroless plating of the pillars can be used. In one example, the rod surfaces are sensitized, activated and plated using appropriate chemicals and electroless plating solutions. Upon completion, the photo resist is stripped and the same process is repeated on the other side. Upon completion, the rod surfaces on both sides are metallized, providing full coverage electrodes over the PZT sensor elements ends.

The electroded composite sensor array can be further processed to fabricate devices. For example, circuits are applied over the sensor elements and the epoxy circuit board surface by photolithography and electroless plating. Either dry or wet film negative photo resist is applied on one surface. A photo mask is aligned to the sensor elements, locked in place in a vacuum alignment frame, and exposed with UV light. After development, that process is repeated on the other side. The resulting sensor/board is sensitized and activated, the photo resist is stripped and copper, nickel and gold are then successively applied using appropriate chemicals, and electroless and immersion plating solutions.

Another embodiment of the invention, therefore, relates to a method of sensitizing and electroless plating of a polymer composite comprising an array of piezoelectric ceramic pillars. The method comprises contacting the composite comprising an array of ceramic pillars with a plating solution comprising a metal chloride salt and plating the metal on the surface of the pillars. In one example of the method, copper (I and/or II) chloride salts are added to the plating bath to facilitate the plating of a metal, such as copper, nickel and gold onto pillar surfaces comprising PZT ceramic. See also, for example, electroless plating of PZT ceramics as described in a co-pending, commonly-owned U.S. Patent Application, entitled “Electroless Plating of Piezoelectric Ceramic”, by D. Halpert et al., Appl. No. to be assigned, filed herewith (Atty. Docket No. 1823.1230000), which is incorporated herein by reference in its entirety for all purposes.

The method also comprises liquid writing of photo lithographic micro features for chemical processing.

The composite sensor array is then polled by applying appropriate voltage at an appropriate temperature for an appropriate time through the applied circuits/electrodes. The parameter values vary due to the ceramic type and thickness of the array.

Over and under layers of materials can be applied to protect the circuits on the contact side and to provide an air interface to the sensor elements on the opposite side.

The electrical components are applied to the circuit board and the integrated sensor/board assembly is ready for testing and assembly with other system components.

Another embodiment of the present invention relates to a method of replicating high aspect micro features comprising silicone.

Another embodiment of the present invention relates to a transfer mold comprising a polymer. The polymer can be any polymer capable of forming a transfer mold for the molding of silicone structures, preferably, the polymer is a polyurethane.

Another embodiment of the present invention relates to a method of forming a polymer/ceramic using vacuum and/or pressure.

It will be understood by those skilled in the art that various changes in form and details may be made therein without departing from the spirit and scope of the present invention as defined in the appended claims. Thus, the breadth and scope of the present invention should not be limited by any of the above-described exemplary embodiments, but should be defined only in accordance with the following claims and their equivalents.

1. A method of manufacturing a device, comprising:
contacting a ceramic powder with a first polymer and surfactant to form a slip mixture;
mixing said slip mixture;
injecting said slip mixture into a mold to form a green body;
removing said mold from said green body;
sintering said green body to form a sintered ceramic body; and
embedding said sintered ceramic body in a second polymer to form a composite.

2. The method of claim 1, wherein said ceramic powder is piezoelectric ceramic powder.

3. The method of claim 2, wherein said piezoelectric ceramic powder is selected from the group consisting of lead zirconate titanate (PZT), lead niobium titanate (PNT) and lead scandium niobium titanate (PSNT).

4. The method of claim 1, wherein said first polymer is an epoxy, urethane or polyester.

5. The method of claim 4, wherein said first polymer is a two-part epoxy polymer.

6. The method of claim 1, wherein said slip mixture further comprises a dispersant.

7. The method of claim 1, wherein said mixing step comprises kinetic shear mixing said slip mixture.

8. The method of claim 7, wherein said mixing step further comprises kinetic shear mixing said slip mixture under reduced pressure.

9. The method of claim 1, wherein said injecting step comprises injecting said slip mixture into said mold at a pressure of about 5-100 p.s.i.

10. The method of claim 1, wherein said injecting step comprises injecting said slip mixture into said mold at a temperature of about 20-40° C.

11. The method of claim 1, wherein said mold is a closed mold.

12. The method of claim 11, wherein said mold is a low durometer mold having hardness of less than about 40 A.

13. The method of claim 12, wherein said mold is selected from the group consisting of a silicone mold, a polyester mold and a polyurethane mold.

14. The method of claim 13, wherein said silicone mold comprises a mold area within said silicone mold, said mold area having a reverse shape of the net shape green body being formed.

15. The method of claim 14, wherein said reverse shape comprises a plurality of microsized wells having depth of about 300-400 μm, widths of about 30-50 μm and center-to-center spacing between said wells of about 20-60 μm.

16. The method of claim 1, further comprising after said injecting step and before said removing step curing said green body.

17. The method of claim 14, wherein said curing step comprises heating said green body.

18. The method of claim 14, wherein said curing step comprises heating said green body at a temperature of about 40-80° C.

19. The method of claim 1, wherein said net-shaped green body comprises a plurality of microsized elements.

20. The method of claim 16, wherein said microsized elements comprise a plurality of rectangular or cylindrical elements.

21. The method of claim 1, wherein said sintering step comprises heating said net-shaped green body to a temperature sufficient to incinerate said polymer.

22. The method of claim 21, wherein said temperature is about 500-1500° C.

23. The method of claim 1, wherein said second polymer is selected from the group consisting of epoxy, polyester, polyurethane and polycarbonate.

24. The method of claim 1, wherein said embedding step further comprises embedding said sintered ceramic body in an epoxy polymer to form said composite.

25. The method of claim 24, wherein said epoxy polymer further comprises ceramic or glass.

26. The method of claim 1, further comprising machining said composite to expose at least one surface of said sintered ceramic body in said composite.

27. The method of claim 1, further comprising forming contacts to said composite to provide electrical connectivity to said sintered ceramic body.

28. The method of claim 27, wherein said forming step comprises plating metal on at least one surface of said composite.

29. The method of claim 27, further comprising:
addressing said sintered ceramic body with electronic components to form said device.

30. A polymer-ceramic composite produced according to the method of claim 1.

31. A transducer comprising the polymer-ceramic composite of claim 30.

32. A polymer-ceramic composite comprising a plurality of ceramic elements disposed in a polymer matrix, wherein said elements have dimensions of 150-250 μm in height, 35-60 μm widths and 30-60 μm center-to-center separation between said elements.

33. The composite of claim 32, wherein said polymer is selected from the group consisting of epoxy, polyester, polyurethane, polycarbonate, polyamide and co-polymers thereof.

34. An apparatus for forming a net shaped green body in a molding operation, comprising:
a mold having a first surface area, an injector port and a vacuum port; and
a supplemental mold having a second surface area, wherein said first and second surface areas form a mold space that substantially corresponds to a reverse shape of the net shape green body formed after material for the green body is injected through the injector port in the presence of a first vacuum pressure applied to the vacuum port.

35. The apparatus of claim 34, further comprising:
a mold assembly that can receive said mold and said supplemental mold, said mold assembly having at least one assembly vacuum port for providing a vacuum pressure to hold said mold and said supplemental mold within said mold assembly during the molding operation.

36. The apparatus of claim 35, wherein said mold assembly includes top and bottom mold vacuum chucks, and said mold includes a recess region such that said supplemental mold can be placed within the recess region of said mold, and said mold and said supplemental mold can be placed in between said top and bottom vacuum chucks.

37. The apparatus of claim 34, wherein said supplemental mold comprises a thin, flexible mold made of silicone rubber with the second surface area comprising an array of microsized wells.

38. The apparatus of claim 34, wherein said reverse shape comprises a back surface and a front surface, the front surface comprising a plurality of microsized wells having a depth of about 300-400 μm, widths of about 30-50 μm and center-to-center spacing between said wells of about 20-60 μm.
